(19) United States
(12) Patent Application Publication
(10) Pub. No.: US 2026/0142193 A1
(43) Pub. Date: May 21, 2026

(54) MEMBRANE-ELECTRODE ASSEMBLY AND FUEL CELL COMPRISING SAME

(71) Applicant: KOLON INDUSTRIES, INC., Seoul (KR)

(72) Inventors: Jung Ho KIM, Seoul (KR); Jun Young KIM, Seoul (KR); Kah Young SONG, Seoul (KR); Nak Won KONG, Seoul (KR); Eun Su LEE, Seoul (KR); Hyeong Su KIM, Seoul (KR); Kyoung Sik NAM, Seoul (KR); Ju Sung LEE, Seoul (KR); Chan Mi PARK, Seoul (KR)

(21) Appl. No.: 19/140,376

(22) PCT Filed: May 25, 2023
(86) PCT No.: PCT/KR2023/007203

§ 371 Date: Jun. 18, 2025

(30) Foreign Application Priority Data
Jun. 14, 2022 (KR) 10-2022-0072435

(51) Int. Cl. H01M 4/90; H01M 4/86; H01M 8/10; H01M 8/1004

(52) U.S. Cl. CPC H01M 4/90; H01M 4/8605; H01M 8/1004; H01M 2008/1095

(57) ABSTRACT

Provided is a membrane-electrode assembly, of which both performance and durability are improved. An embodiment of the present disclosure provides a membrane-electrode assembly comprising a polymer electrolyte membrane and a catalyst layer disposed on at least one surface of the polymer electrolyte membrane, wherein the catalyst layer comprises platelet mesoporous carbon having a short-axis pore form and has no metal nanoparticles supported thereon, the catalyst layer being a single layer.

### TECHNICAL FIELD

The present disclosure relates to a membrane-electrode assembly and a fuel cell comprising the same, and more particularly, to a membrane-electrode assembly, of which both performance and durability are improved, and a fuel cell comprising the same.

### BACKGROUND ART

A fuel cell is a cell that directly converts chemical energy generated by the oxidation of fuel into electric energy, and has attracted attention as a next-generation energy source due to its high energy efficiency and environmentally friendly characteristics such as emission of a small amount of pollutant. Such ae fuel cell generally has a structure in which an anode and a cathode are disposed on both sides of a polymer electrolyte membrane, respectively, with the electrolyte membrane interposed therebetween, and such a structure is called a membrane-electrode assembly (MEA).

Fuel cells may be classified into alkaline electrolyte membrane fuel cells, polymer electrolyte membrane fuel cells (PEMFC), and the like, depending on the type of the electrolyte membrane. Among them, the polymer electrolyte membrane fuel cells have attracted attention as power sources for portable, automotive, and residential applications, due to advantages such as a low operating temperature below 100° C., fast startup and response characteristics, and excellent durability.

A representative example of such a polymer electrolyte membrane fuel cell may include a proton exchange membrane fuel cell (PEMFC) that uses hydrogen gas as fuel, and the like.

The following reaction may occur in the polymer electrolyte membrane fuel cell. First, when fuel such as hydrogen gas is supplied to an anode, hydrogen ions and electrons are generated by an oxidation reaction of hydrogen gas at the anode. The generated hydrogen ions are transferred to a cathode through a polymer electrolyte membrane, and the generated electrons are transferred to the cathode through an external circuit. At the cathode, oxygen gas is supplied, and combines with hydrogen ions and electrons to produce water by a reduction reaction.

### DISCLOSURE

### Technical Problem

An object of the present disclosure is to provide a membrane-electrode assembly of which both performance and durability are improved.

Another object of the present disclosure is to provide a membrane-electrode assembly including a catalyst layer that facilitates material transfer.

The objects of the present disclosure are not limited to those mentioned above. Other objects and advantages of the present disclosure that are not mentioned will be understood from the following description and will be more clearly understood by the embodiments of the present disclosure. In addition, it will be readily appreciated that the objects and advantages of the present disclosure may be realized by the means and combinations thereof set forth in the claims.

### Technical Solution

An embodiment of the present disclosure for achieving the above object provides a membrane-electrode assembly including a polymer electrolyte membrane; and a catalyst layer disposed on at least one surface of the polymer electrolyte membrane, wherein the catalyst layer includes platelet mesoporous carbon having no metal nanoparticles supported thereon, and the catalyst layer is a single layer.

Another embodiment of the present disclosure for achieving the above object may provide a fuel cell comprising the membrane-electrode assembly as described above.

The means for solving the above-described problems do not encompass all features of the present disclosure. Various features of the present disclosure, and the advantages and effects thereof will be more fully understood with reference to the specific embodiments set forth hereinafter.

### Advantageous Effects

According to an embodiment of the present disclosure, a membrane electrode of which both performance and durability are improved may be provided. In addition, according to an embodiment of the present disclosure, a membrane-electrode assembly of which performance is improved by improving material transfer and ion transfer paths by a pore structure and improving porosity of the entire catalyst layer and durability is improved by reducing the degradation of a catalyst by easy material transfer even though a fuel cell is operated for a long time and which includes a catalyst layer.

In addition to the above-mentioned effects, the specific effects of the present disclosure will be described in conjunction with the specific contents for carrying out the present disclosure below.

### BRIEF DESCRIPTION OF DRAWINGS

FIG. 1 is a schematic view showing platelet mesoporous carbon according to various embodiments of the present disclosure.

FIG. 2 is a schematic view showing the shape in a catalyst layer according to various embodiments of the present disclosure.

FIG. 3 is a schematic view for illustrating a fuel cell according to an embodiment of the present disclosure.

FIG. 4 is a UHR-SEM image of platelet mesoporous carbon having aligned nanofibers according to Synthesis Example 1-1.

FIG. 5 is a UHR-SEM image of platelet mesoporous carbon having aligned nanotubes according to Synthesis Example 2-1.

FIG. 6 is a cross-sectional SEM image of a catalyst layer including platelet mesoporous carbon having no metal nanoparticles supported thereon according to Example 1-2.

FIG. 7 is a UHR-SEM image of a catalyst layer including platelet mesoporous carbon having no metal nanoparticles supported thereon according to Example 2-2.

FIG. 8 is a performance evaluation result of membrane-electrode assemblies manufactured by Examples and Comparative Examples under conditions of 80° C., 100% RH, and atmospheric pressure.

### MODE FOR DISCLOSURE

Hereinafter, each configuration of the present disclosure will be described in more detail so that a person having ordinary knowledge in the art to which the present disclosure belongs can easily carry out the present disclosure, but this is only one example, and the scope of the rights of the present disclosure is not limited by the following contents.

An embodiment of the present disclosure provides a membrane-electrode assembly including a polymer electrolyte membrane and a catalyst layer disposed on at least one surface of the polymer electrolyte membrane, wherein the catalyst layer includes platelet mesoporous carbon having no metal nanoparticles supported thereon, and the catalyst layer is a single layer. According to an embodiment of the present disclosure, by using platelet mesoporous carbon having a large specific surface area and a short-axis pore form to facilitate material transfer and ion transfer, both the performance and durability of the membrane-electrode assembly may be improved.

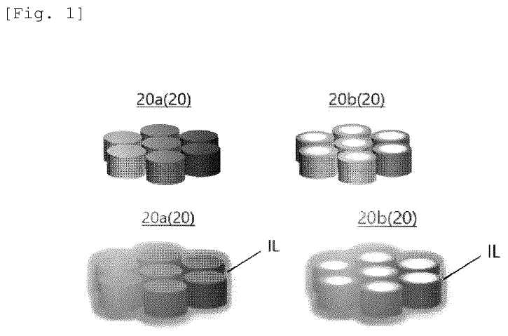

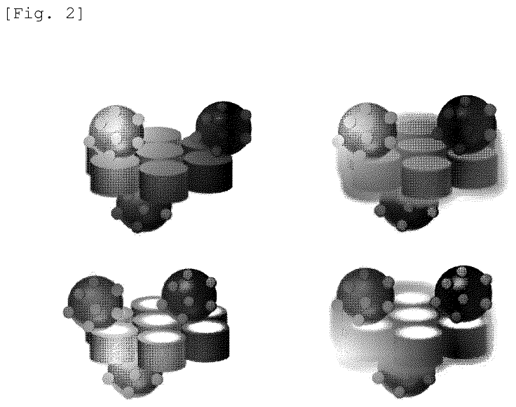

Hereinafter, the configuration of the present disclosure will be described in more detail with reference to FIGS. 1 and 2.

FIG. 1 is a schematic view showing platelet mesoporous carbon according to various embodiments of the present disclosure.

FIG. 2 is a schematic view showing the shape in a catalyst layer according to various embodiments of the present disclosure.

Referring to FIGS. 1 and 2, the membrane-electrode assembly according to the present disclosure includes a polymer electrolyte membrane. The polymer electrolyte membrane is a commercially available polymer electrolyte membrane in the art, and may include, for example, an ion conductor.

A catalyst layer 20 according to the present disclosure may be disposed on at least one surface of the polymer electrolyte membrane, and the catalyst layer 20 may include platelet mesoporous carbon having no metal nanoparticles (or metal catalyst particles) supported thereon. That is, the catalyst layer 20 according to an embodiment of the present disclosure may be disposed on one surface of the polymer electrolyte membrane, and a commercial catalyst layer may be disposed on the other surface opposite to the one surface. The catalyst layer 20 according to another embodiment of the present disclosure may be disposed on both surfaces of the polymer electrolyte membrane. Conventionally, there was a problem that performance of the membrane-electrode assembly is reduced due to irregular material transfer and ion transfer paths when the fuel cell was operated, and the membrane-electrode assembly is easily degraded when the fuel cell is operated for a long time. According to an embodiment of the present disclosure, the performance of the membrane-electrode assembly may be improved by improving the material transfer and ion transfer paths through a short-axis pore structure and improving porosity of the entire catalyst layer and the durability of the membrane-electrode assembly may be improved by preventing easy degradation of the membrane-electrode assembly caused by easy material transfer when the fuel cell is operated for a long time.

According to an embodiment of the present disclosure, an ionomer layer IL may be coated on a surface and in pores of the platelet mesoporous carbons 20a and 20b. According to an embodiment of the present disclosure, by coating the ionomer layer IL on the surface and in the pores of the platelet mesoporous carbons 20a and 20b, ion conductivity may be further increased through a short ion transfer path, and interfacial adhesion between the polymer electrolyte membrane and the electrode may be improved, resulting in a significant improvement in the durability of the membrane-electrode assembly. A thickness of the ionomer layer IL may be 1 to 7 nm (nanometers), specifically 1.5 to 6 nm (nanometers), and more specifically 2 to 5 nm (nanometers). When the thickness of the ionomer layer is less than the above range, the ion conductivity may be reduced, and when the thickness exceeds the above range, only ion transfer may be improved and material transfer may be hindered.

Specifically, the ionomer layer IL may include a first ionomer. An equivalent weight (EW) of the first ionomer may be 600 to 1,200 g/eq. When the equivalent weight of the first ionomer falls within the above range, the interfacial adhesion between the polymer electrolyte membrane and a first catalyst layer may be improved, and both the ion conductivity performance and durability performance of a catalyst may be improved.

The first ionomer may be any one selected from the group consisting of a fluorine-based ionomer, a hydrocarbon-based ionomer, and a mixture thereof.

The fluorine-based ionomer may be any one selected from, for example, the group consisting of a fluorine-based polymer containing fluorine atoms in a main chain, such as poly(perfluorosulfonic acid), poly(perfluorocarboxylic acid), a copolymer of tetrafluoroethylene and fluorovinyl ether including sulfonic acid groups, a polystyrene-graft-ethylenetetrafluoroethylene copolymer, a polystyrene-graft-polytetrafluoroethylene copolymer, or a mixture thereof.

The hydrocarbon-based ionomer may be any one selected from, for example, the group consisting of sulfonated polyimide (S-PI), sulfonated polyarylethersulfone (S-PAES), sulfonated polyetheretherketone (S-PEEK), sulfonated polybenzimidazole (S-PBI), sulfonated polysulfone (S-PSU), sulfonated polystyrene (S-PS), sulfonated polyphosphazene, sulfonated polyquinoxaline, sulfonated polyketone, sulfonated polyphenylene oxide, sulfonated polyether sulfone, sulfonated polyether ketone, sulfonated polyphenylene sulfone, sulfonated polyphenylene sulfide, sulfonated polyphenylene sulfide sulfone, sulfonated polyphenylene sulfide sulfone nitrile, sulfonated polyarylene ether, sulfonated polyarylene ether nitrile, sulfonated polyarylene ether ether nitrile, sulfonated polyarylene ether sulfone ketone, and a mixture thereof.

In order to coat an ionomer layer IL on the surface of the platelet mesoporous carbon, a method of homogeneous mixing in a solid state using a resonant acoustic mixer may be utilized, or a method of homogeneous mixing in an aqueous solution using devices such as a ball mill, a homogenizer, or a high-pressure disperser may be utilized. For example, as a method for coating the ionomer layer, a method may be used in which a mixture of a polymer powder containing the first ionomer and the platelet mesoporous carbon, in a weight ratio (polymer powder: platelet mesoporous carbon) of 1:20 to 1:200, is homogeneously mixed using a resonant acoustic mixer at a gravitational acceleration of 40 to 100 G for 3 to 60 minutes, and then heat-treated at a temperature of 100 to 160° C. for 30 to 100 minutes. However, the technical spirit of the present disclosure is not limited thereto, and various methods for coating the ionomer layer on the surface of the platelet mesoporous carbon may be applied.

The platelet mesoporous carbon according to an embodiment of the present disclosure may have pores included in nanofibers or nanotubes that may extend in a direction perpendicular to the plane of the polymer electrolyte membrane. The nanofibers and nanotubes may each independently have a height of 50 to 600 nm (nanometers). When the height of the nanofibers and nanotubes falls within the above range, both the durability and performance of the membrane-electrode assembly may be improved.

The platelet mesoporous carbon according to another embodiment of the present disclosure may have pores included in nanofibers or nanotubes that may extend in a direction non-perpendicular to the plane of the polymer electrolyte membrane. When the pores of the platelet mesoporous carbon extend in a direction non-perpendicular to the plane of the polymer electrolyte membrane, the shape of the pores may be maintained in the catalyst layer, thereby improving durability.

The platelet mesoporous carbon according to the present disclosure may be in a form in which nanofibers or nanotubes are aligned in a short-axis direction. Specifically, the platelet mesoporous carbon 20a having aligned nanofibers may have a mesopore size of 2 to 20 nm (nanometers) and a height of 50 to 600 nm (nanometers), and the platelet mesoporous carbon 20b having aligned nanotubes may have a mesopore size of 2 to 30 nm (nanometers) and a height of 50 to 600 nm (nanometers). The platelet mesoporous carbon including the nanofibers or nanotubes in a platelet form may each independently have a width or length of 100 to 1,500 nm (nanometers), specifically 200 to 1, 200 nm (nanometers), and more specifically 300 to 1,000 nm (nanometers).

Referring to FIG. 2, the catalyst layer according to the present disclosure may further include a carrier and metal nanoparticles supported on the carrier.

The carrier may be one selected from the group consisting of a carbon-based carrier, a porous inorganic oxide, a zeolite, and combinations thereof. The carbon-based carrier may be selected from, for example, graphite, Super P, carbon fiber, carbon sheet, carbon black, Ketjen black, Denka black, acetylene black, carbon nanotube (CNT), carbon sphere, carbon ribbon, fullerene, activated carbon, carbon nanofiber, carbon nanowire, carbon nanoball, carbon nanohorn, carbon nanocage, carbon nanoring, carbon aerogel, graphene, stabilized carbon, activated carbon, and at least one combination thereof, but is not limited thereto. The porous inorganic oxide may be one or more selected from the group consisting of, for example, zirconia, alumina, titania, silica, and ceria. Preferably, a specific surface area of the carrier may be 50 m²/g or more, and the average particle diameter may be 10 to 300 nm (nanometers). When the specific surface area of the carrier is less than the above range, uniform distribution of the metal nanoparticles may not be achieved.

The metal nanoparticles may be, for example, platinum-based metals or non-platinum-based metals. The platinum-based metal may be platinum (Pt) or a platinum-based alloy (Pt-M). The M may be one or more selected from the group consisting of palladium (Pd), ruthenium (Ru), iridium (Ir), osmium (Os), gallium (Ga), titanium (Ti), vanadium (V), chromium (Cr), manganese (Mn), iron (Fe), cobalt (Co), nickel (Ni), copper (Cu), silver (Ag), gold (Au), zinc (Zn), tin (Sn), molybdenum (Mo), tungsten (W), lanthanum (La), and rhodium (Rh). As the platinum-based alloy (Pt-M), Pt—Pd, Pt—Sn, Pt—Mo, Pt—Cr, Pt—W, Pt—Ru, Pt—Ni, Pt—Co, Pt—Y, Pt—Ru—W, Pt—Ru—Ni, Pt—Ru—Mo, Pt—Ru—Rh—Ni, Pt—Ru—Sn—W, Pt—Ru—Ir—Ni, Pt—Co, Pt—Co—Mn, Pt—Co—Ni, Pt—Co—Fe, Pt—Co—Ir, Pt—Co—S, Pt—Co—P, Pt—Fe, Pt—Fe—Ir, Pt—Fe—S, Pt—Fe—P, Pt—Au—Co, Pt—Au—Fe, Pt—Au—Ni, Pt—Ni, Pt—Ni—Ir, Pt—Cr, Pt—Cr—Ir, or a mixture of two or more thereof may be used. As the non-platinum-based metal, one or more selected from the group consisting of palladium (Pd), ruthenium (Ru), iridium (Ir), osmium (Os), and a non-platinum-based alloy may be used. As the non-platinum-based alloy, Ir—Fe, Ir—Ru, Ir—Os, Co—Fe, Co—Ru, Co—Os, Rh—Fe, Rh—Ru, Rh—Os, Ir—Ru—Fe, Ir—Ru—Os, Rh—Ru—Fe, Rh—Ru—Os, Fe—N, Fe—P, Co—N, or a mixture of two or more thereof may be used.

As a method for manufacturing a membrane-electrode assembly according to the present disclosure, a decal transfer method of a batch type or a roll-to-roll type, or a direct coating method may be used to form a catalyst layer on at least one surface of the polymer electrolyte membrane.

The polymer electrolyte membrane according to another embodiment of the present disclosure may be a reinforced composite membrane in which an ion conductor is impregnated into a porous support. The ion conductor may include a second ionomer, and the second ionomer may be the same as or different from the first ionomer.

The porous support according to the present disclosure may be a fluorine-based support or a nanoweb support. Specifically, the fluorine-based support may be, for example, expanded polytetrafluoroethylene (e-PTFE) having a microstructure of polymer fibrils, or a microstructure in which nodes are interconnected by fibrils. In addition, a film having a microstructure of polymer fibrils without nodes may also be used as the porous support.

The fluorine-based support may include a perfluorinated polymer. The porous support may be a more porous and stronger porous support obtained by extruding dispersion-polymerized PTFE into a tape in the presence of a lubricant and stretching the resulting material. In addition, the amorphous content of the PTFE may also be increased by heat-treating the e-PTFE at a temperature exceeding the melting point of PTFE (about 342° C.). The e-PTFE film manufactured by the above method may have micropores with various diameters and porosity. The e-PTFE film manufactured by the above method may have a porosity of least 35%, and may have micropores with a diameter of about 0.01 to 1 μm (micrometers).

The nanoweb support according to an embodiment of the present disclosure may be a non-woven fibrous web composed of a plurality of randomly oriented fibers. The non-woven fibrous web refers to a sheet having a structure of individual fibers or filaments that are interlaid, but not in the same manner as a woven fabric. The non-woven fibrous web may be manufactured by any one method selected from the group consisting of carding, garneting, air-laying, wet-laying, melt blowing, spun bonding, and stitch bonding. The fibers may include one or more polymeric materials, and any material that is generally used as a fiber-forming polymer material may be used, and specifically, a hydrocarbon-based fiber-forming polymer material may be used. For example, the fiber-forming polymeric material may include any one selected from the group consisting of polyolefins such as polybutylene, polypropylene, and polyethylene, polyesters such as polyethylene terephthalate and polybutylene terephthalate, polyamides (nylon-6 and nylon-6, 6), polyurethane polybutene, polylactic acid, polyvinyl alcohol, polyphenylene sulfide, polysulfones, liquid crystalline polymers, polyethylene-co-vinyl acetate, polyacrylonitrile, cyclic polyolefins, polyoxymethylene, polyolefin-based thermoplastic elastomers, and combinations thereof. However, the technical scope of the present disclosure is not limited thereto.

The nanoweb support according to an embodiment of the present disclosure may be a support in which nanofibers are integrated in a nonwoven form containing a plurality of pores. The nanofibers exhibit excellent chemical resistance and hydrophobicity, so a hydrocarbon-based polymer that does not pose a risk of shape deformation due to moisture in a high-humidity environment may be preferably used. Specifically, as the hydrocarbon-based polymers, a polymer selected from the group consisting of nylon, polyimide, polyaramid, polyetherimide, polyacrylonitrile, polyaniline, polyethylene oxide, polyethylene naphthalate, polybutylene terephthalate, styrene butadiene rubber, polystyrene, polyvinyl chloride, polyvinyl alcohol, polyvinylidene fluoride, polyvinyl butylene, polyurethane, polybenzoxazole, polybenzimidazole, polyamideimide, polyethylene terephthalate, polyphenylene sulfide, polyethylene, polypropylene, copolymers thereof, and a mixture thereof may be used. Among these, polyimide having superior heat resistance, chemical resistance, and dimensional stability may be preferably used.

The nanoweb support is a collection of nanofibers randomly arranged and manufactured by electrospinning. In this case, considering the porosity and thickness of the nanoweb, the nanofibers preferably have an average diameter of 40 to 5,000 nm (nanometers) when the average diameter of 50 fibers is measured using a scanning electron microscope (JSM6700F, JEOL) and calculated from the average. When the average diameter of the nanofibers is less than the above range, the mechanical strength of the porous support may be reduced, and when the average diameter of the nanofibers exceeds the above range, the porosity may be significantly reduced, and the thickness may be increased.

The thickness of the non-woven fibrous web may be 10 to 50 μm (micrometers), and specifically, 15 to 43 μm. When the thickness of the non-woven fibrous web is less than the above range, the mechanical strength may be reduced, and when the thickness of the non-woven fibrous web exceeds the above range, resistance loss may increase, and weight reduction and integration may be reduced. The non-woven fibrous web may have a basic weight of 5 to 30 mg/cm². When the basic weight of the non-woven fibrous web is less than the above range, visible pores may be formed, making it difficult to function as a porous support, and when the basic weight of the non-woven fibrous web exceeds the above range, it may be manufactured in the form of paper or fabric, with substantially no pores.

The porous support according to the present disclosure may have a porosity of 30 to 90%, and preferably 60 to 85%. When the porosity of the porous support is less than the above range, the impregnation of the ion conductor may be reduced, and when the porosity of the porous support exceeds the above range, the shape stability may be reduced, and thus a subsequent process may not be smoothly performed. The porosity may be calculated by the ratio of the air volume in the porous support to the total volume of the porous support according to Equation 1 below. In this case, the total volume may be calculated by preparing a rectangular sample and measuring its width, length, and thickness. The air volume may be obtained by measuring the mass of the sample and then subtracting the polymer volume calculated inversely from the density, from the total volume.

$$Porosity ( \% ) = ( air volume in porous support / total volume of porous support ) \times 100 \qquad [ Equation 1 ]$$

### 2. Fuel Cell

Another embodiment of the present disclosure may provide a fuel cell including the membrane-electrode assembly.

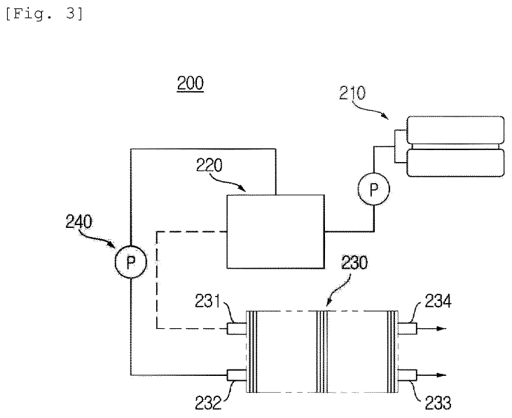

FIG. 3 is a schematic view illustrating a fuel cell according to an embodiment of the present disclosure.

Referring to FIG. 3, the fuel cell 200 according to the present disclosure may include a fuel supply unit 210 for supplying a mixed fuel of fuel and water, a reforming unit 220 for reforming the mixed fuel to generate a reformed gas containing hydrogen gas, a stack 230 for generating electrical energy by causing an electrochemical reaction between the reformed gas containing hydrogen gas supplied from the reforming unit 220 and an oxidant, and an oxidant supply unit 240 for supplying the oxidant to the reforming unit 220 and the stack 230.

The stack 230 may include a plurality of unit cells for generating electrical energy by inducing oxidation/reduction reactions between a reformed gas containing hydrogen gas supplied from the reforming unit 220 and an oxidant supplied from the oxidant supply unit 240.

Each unit cell refers to a cell unit for generating electricity, and may include a membrane-electrode assembly for oxidizing/reducing oxygen in the reforming gas containing hydrogen gas and the oxidant, and a separator (also referred to as a bipolar plate, hereinafter referred to as a ‘separator’) for supplying the reformed gas containing hydrogen gas and the oxidant to the membrane-electrode assembly. The separators are disposed on both sides of the membrane-electrode assembly with the membrane-electrolyte membrane interposed therebetween. In this case, the separators respectively located at the outermost sides of the stack are also specifically referred to as end plates.

Among the separators, the end plate may include a first supply pipe 231 in the shape of a pipe for injecting reformed gas containing hydrogen gas supplied from the reforming unit 220, and a second supply pipe 232 in the shape of a pipe for injecting oxygen gas. The other end plate may include a first discharge pipe 233 for discharging reformed gas containing hydrogen gas that is ultimately unreacted and remains, from a plurality of unit cells to the outside, and a second discharge pipe 234 for discharging an oxidizer that is ultimately unreacted and remains, from the above unit cells to the outside.

In the fuel cell, the separator, fuel supply unit, and oxidant supply unit constituting the power generation unit are used in a conventional fuel cell. Therefore, a detailed description thereof will be omitted herein.

Hereinafter, Examples of the present disclosure will be described in detail to enable those skilled in the art to easily carry out the present disclosure. However, these Examples are merely one example, and the scope of the present disclosure is not limited to the contents described below.

### Synthesis Example 1: Synthesis of Platelet Mesoporous Silica

To synthesize platelet mesoporous silica to be used as a template, ZrOCl₂·8H₂O (0.32 g) and poly(ethylene glycol)-block-poly(propylene glycol)-block-poly(ethylene glycol) (Pluronic P123; 2.0 g) were dissolved in a 2.0 M HCl aqueous solution, 4.2 g of tetraethyl orthosilicate (TEOS) was added and then hydrolysis was performed at 35° C. for 30 minutes. 1.0 g of trimethylbenzene (TMB) was added to the hydrolyzed mixed solution, and hydrolysis and condensation polymerization were performed at 35° C. for 12 hours. Then, the resultant was subjected to hydrothermal treatment at 90° C. for 5 hours, followed by filtration, drying, and calcination at 550° C. for 6 hours to synthesize platelet mesoporous silica.

### Synthesis Example 2: Synthesis of Non-Platelet Mesoporous Silica

The conventional mesoporous silica to be used as a template was prepared by dissolving poly(ethylene glycol)-block-poly(propylene glycol)-block-poly(ethylene glycol) (Pluronic P123 2.0 g) in a 2.0 M HCl aqueous solution, adding 4.2 g of tetraethylorthosilicate (TEOS), and performing hydrolysis and condensation polymerization at 35° C. for 12 hours. Then, the resultant was filtered, dried, and calcined at 550° C. for 6 hours to synthesize non-platelet non-mesoporous silica.

### Manufacturing Example 1-1: Manufacturing of Platelet Mesoporous Carbon Having Aligned Nanofibers

1.0 g of platelet mesoporous silica (length: 600 nm, height: 200 nm, and mesopore size: 10 nm) manufactured according to the Synthesis Example 1 was used as a template, and 0.6 g of phenol formaldehyde resin, a polymer precursor, was filled into the mesopores. Then, polymerization was performed at 140° C., and a carbonization step was performed at 1,000° C. under inert gas conditions. Subsequently, the mold was removed to finally manufacture platelet mesoporous carbon having aligned nanofibers with a length of 600 nm, a height of 200 nm, and an average mesopore size of 6 nm between the nanofibers.

### Manufacturing Example 1-2: Manufacturing of Platelet Mesoporous Carbon Having Aligned Nanofiber Form Coated with Ionomer Layer on Surface and in Pores

The platelet mesoporous carbon manufactured according to Manufacturing Example 1-1 and perfluorosulfonic acid (PFSA) having an equivalent weight of 800 g/eq were placed in a container at a weight ratio of 0.8:1, and then mixed in a solid phase for 30 minutes at a gravitational acceleration of 60 G using a resonant acoustic mixer (RAM) to prepare a mixture. The mixture was heat-treated at 130° C. for 60 minutes to form an ionomer layer having a thickness of 3.0 nm on the surface and pores of the platelet mesoporous carbon.

### Manufacturing Example 2-1: Manufacturing of Platelet Mesoporous Carbon Having Aligned Nanotubes

1.0 g of platelet mesoporous silica (length: 600 nm, height: 200 nm, and mesopore size: 10 nm) manufactured according to Synthesis Example 1 was acid-treated using AlCl₃ to manufacture an acid-treated mold. Using the acid-treated mold, the same method as in Manufacturing Example 1-1 was used to manufacture platelet mesoporous carbon having aligned nanotubes with a length of 600 nm, a height of 200 nm, and a pore diameter of 8 nm, and having an average mesopore size of 6 nm between the nanotubes.

### Manufacturing Example 2-2: Synthesis of Platelet Mesoporous Carbon Having Aligned Nanotubes Coated with Ionomer Layer on Surface and in Pores

An ionomer layer having a thickness of 3.0 nm was formed on the surface and in the pores of the platelet mesoporous carbon in the same manner as in Manufacturing Example 1-2, except that the platelet mesoporous carbon manufactured according to Manufacturing Example 2-1 was used.

### Manufacturing Example 3: Manufacturing of Non-Platelet Mesoporous Carbon

Using 1.0 g of conventional mesoporous silica (length: 700 nm, height: 700 nm, and mesopore size: 7 nm) manufactured according to Synthesis Example 2 as a template, the same method as in Manufacturing Example 1-1 was used to manufacture non-porous mesoporous carbon having an average mesopore size of 5 nm with a length of 700 nm and a height of 700 nm.

### Experimental Example 1: UHR-SEM Image of Platelet Mesoporous Carbon According to Manufacturing Example 1-1

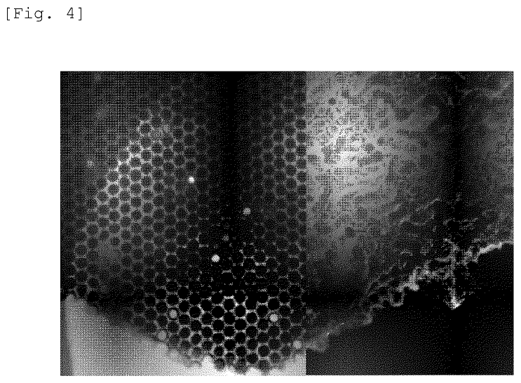

FIG. 4 is an ultra-high-resolution (UHR)-SEM image of the platelet mesoporous carbon having aligned nanofibers, according to Manufacturing Example 1-1.

Referring to FIG. 4, a catalyst layer was formed using the platelet mesoporous carbon having aligned nanofibers and having no metal nanoparticles supported thereon, according to Manufacturing Example 1-1.

### Experimental Example 2: UHR-SEM Image of Platelet Mesoporous Carbon According to Manufacturing Example 2-1

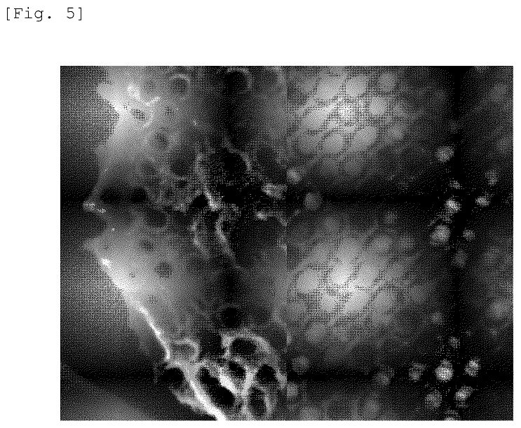

FIG. 5 is a UHR-SEM image of the platelet mesoporous carbon having aligned nanotubes, according to Manufacturing Example 2-1.

Referring to FIG. 5, a catalyst layer was formed using the platelet mesoporous carbon having aligned nanotubes and having no metal nanoparticles supported thereon, according to Manufacturing Example 2-1.

### Manufacturing Example 4: Manufacturing of Membrane-electrode Assembly

### Example 1-1: Manufacturing of Membrane-Electrode Assembly Applied with Unsupported Platelet Mesoporous Carbon According to Manufacturing Example 1-1

### (a) Step: Manufacturing a Polymer Electrolyte Membrane

A polymer electrolyte membrane was manufactured by applying a polymer solution, in which water and isopropanol are mixed at a weight ratio of 1:1 and are further mixed with perfluorosulfonic acid, onto a glass substrate using a doctor blade, gradually heating the applied polymer solution to 80° C. and then drying the heated solution for 4 hours.

### (b) Step: Forming a Single-Layer Catalyst Layer

0.2 g of the platelet mesoporous carbon having no metal nanoparticles supported thereon, according to Synthesis Example 1-1, 1.0 g of a commercial Pt/C catalyst (Tanaka), and 1.3 g of a binder (EW=800) were homogeneously mixed in a solvent using a high shear mixer at 6,000 rpm for 40 minutes. The resulting mixture was subjected to two passes using a high-pressure disperser at 600 bar to prepare an electrode slurry. The electrode slurry was applied to both surfaces of the polymer electrolyte membrane using a slot-die method, and then dried at 80° C. for 5 minutes to form a single-layer catalyst layer having a thickness of 10 μm.

### <Example 1-2: Manufacturing of Membrane-Electrode Assembly Applied with Platelet Mesoporous Carbon Coated with Ionomer Layers Unsupported on Surface and in Pores According to Manufacturing Example 1-2>

A membrane-electrode assembly was manufactured in the same manner as in Example 1-1, except that 0.2 g of the platelet mesoporous carbon coated with an ionomer layer according to Manufacturing Example 1-2 and 1.2 g of a binder (EW=800) were used instead of the platelet mesoporous carbon according to Manufacturing Example 1-1.

### <Example 2-1: Manufacturing of Membrane-Electrode Assembly Applied with Platelet Mesoporous Carbon According to Manufacturing Example 2-1>

A membrane-electrode assembly was manufactured in the same manner as in Example 1-1, except that the platelet mesoporous carbon according to Manufacturing Example 2-1 was used instead of the platelet mesoporous carbon according to Manufacturing Example 1-1.

### <Example 2-2: Manufacturing of Membrane-Electrode Assembly Applied with Platelet Mesoporous Carbon Coated with Ionomer Layer Unsupported on Surface and in Pores According to Manufacturing Example 2-2>

A membrane-electrode assembly was manufactured in the same manner as in Example 1-2, except that the platelet mesoporous carbon coated with the ionomer layer according to Manufacturing Example 2-2 was used instead of the platelet mesoporous carbon coated with an ionomer layer according to Manufacturing Example 1-2.

### Comparative Example 1: Commercial Membrane-Electrode Assembly

A polymer electrolyte membrane was manufactured in the same manner as in Example 1-1. Then, an electrode slurry containing 1.0 g of a commercial Pt/C catalyst (Tanaka) and 1.0 g of a binder (EW=800) was directly coated on both surfaces of the polymer electrolyte membrane to form catalyst layers having a thickness of 8 μm.

### Comparative Example 2: Membrane-Electrode Assembly Applied with Non-Platelet Mesoporous Carbon

A membrane-electrode assembly was manufactured in the same manner as in Example 1-1, except that the conventional mesoporous carbon according to Manufacturing Example 3 was used instead of the platelet mesoporous carbon according to Manufacturing Example 1-1.

### Experimental Example 3: Cross-Sectional SEM Image of Membrane-Electrode Assembly Including Platelet Mesoporous Carbon According to Example 1-2

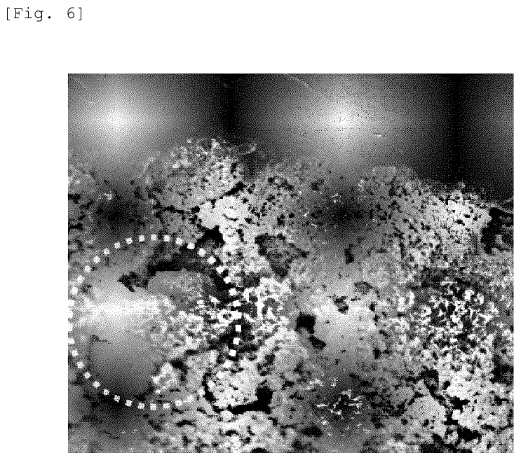

FIG. 6 is a cross-sectional SEM image of a membrane-electrode assembly including platelet mesoporous carbon having aligned nanofibers according to Example 1-2.

Referring to FIG. 6, a catalyst layer was formed using the platelet mesoporous carbon having aligned nanofibers according to Example 1-2.

### Experimental Example 4: Cross-Sectional SEM Image of Membrane-Electrode Assembly Including Platelet Mesoporous Carbon According to Example 2-2

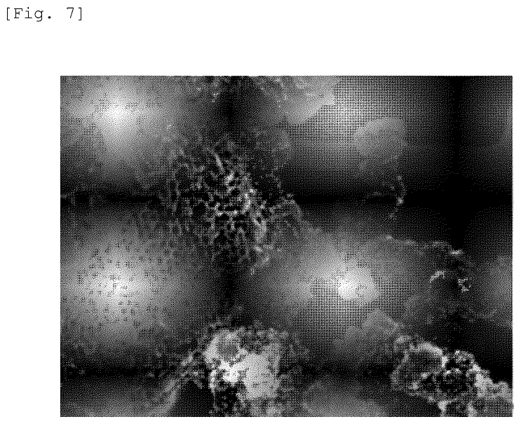

FIG. 7 is a cross-sectional SEM image of a membrane-electrode assembly including a platelet mesoporous carbon layer having aligned nanotubes according to Example 2-2.

Referring to FIG. 7, a catalyst layer was formed using the platelet mesoporous carbon having aligned nanotubes according to Example 2-2.

### Experimental Example 5: Performance Evaluation

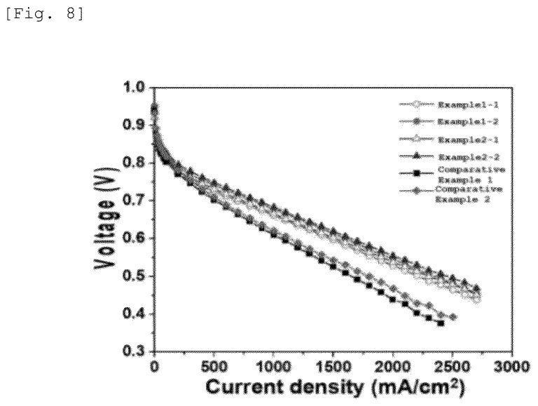

FIG. 8 is a performance evaluation result of membrane-electrode assemblies manufactured by the Examples and Comparative Examples under conditions of 80° C., 100% RH, and atmospheric pressure. Specifically, a fuel cell evaluation station was used to evaluate the performance of the membrane-electrode assemblies.

Referring to FIG. 8, the membrane-electrode assemblies manufactured according to the Examples showed improved performance compared to those manufactured according to the Comparative Examples.

### Experimental Example 6: Results of Catalyst Durability Evaluation of Membrane-Electrode Assemblies

To evaluate the catalyst durability of the membrane-electrode assemblies according to the Examples and the Comparative Examples, a catalyst durability testing protocol of the U.S. Department of Energy (DOE) was employed. Specifically, a fuel cell evaluation station was used to evaluate the catalytic durability of the membrane-electrode assembly.

Evaluation conditions: Under conditions of 80° C. and atmospheric pressure, and using H₂/N₂ gas at a flow rate of 100 ccm for the anode/37.5 ccm for the cathode, 10,000 cycles were performed in the range of 0.6 to 1.0 V at a rate of 50 mV/s, and then the voltage loss was evaluated.

TABLE 1

| | Comp. | Comp. | | | | |
|---|---|---|---|---|---|---|
| | Example | Example | Example | Example | Example | Example |
| Sample | 1 | 2 | 1-1 | 1-2 | 2-1 | 2-2 |
| Voltage | 43 | 36 | 18 | 14 | 17 | 12 |
| loss (mV) | | | | | | |
| (10,000 | | | | | | |
| cycles) | | | | | | |

Referring to Table 1, it can be confirmed that the voltage loss of the Examples was significantly lower than that in the Comparative Examples, indicating that the durability performance of the catalyst was significantly improved.

Although the preferred embodiments of the present disclosure have been described in detail above, the scope of the rights of the present disclosure is not limited thereto, and various modifications and improvements made by those skilled in the art using the basic concept of the present disclosure defined in the following claims also fall within the scope of the rights of the present disclosure.

### DESCRIPTION OF REFERENCE NUMERALS

20: Catalyst layer
IL: Ionomer layer

1. A membrane-electrode assembly comprising:
a polymer electrolyte membrane; and
a catalyst layer disposed on at least one surface of the polymer electrolyte membrane,
wherein the catalyst layer includes platelet mesoporous carbon having no metal nanoparticles supported thereon, and
wherein the catalyst layer is a single layer.

2. The membrane-electrode assembly of claim 1,
wherein an ionomer layer is coated on the surface and in the pores of the platelet mesoporous carbon.

3. The membrane-electrode assembly of claim 2,
wherein the ionomer layer includes a first ionomer, and
wherein the equivalent weight (EW) of the first ionomer is 600 to 1,200 g/eq.

4. The membrane-electrode assembly of claim 3,
wherein the first ionomer is any one selected from the group consisting of a fluorine-based ionomer, a hydrocarbon-based ionomer, and a mixture thereof.

5. The membrane-electrode assembly of claim 1,
wherein the platelet mesoporous carbon is in a form in which nanofibers or nanotubes are aligned in a short-axis direction.

6. The membrane-electrode assembly of claim 5,
wherein each of the nanofibers and nanotubes independently has a height of 50 to 600 nm (nanometers).

7. A fuel cell comprising the membrane-electrode assembly of claim 1.
